(19) United States
(12) Patent Application Publication
(10) Pub. No.: US 2016/0118661 A1
(43) Pub. Date: Apr. 28, 2016

(54) CATHODE MATERIAL, METHOD OF PRODUCING CATHODE MATERIAL, CATHODE, AND LITHIUM ION BATTERY

(71) Applicant: SUMITOMO OSAKA CEMENT CO., LTD., Tokyo (JP)

(72) Inventors: Satoru OSHITARI, Tokyo (JP); Masataka OYAMA, Tokyo (JP); Ryuuta YAMAYA, Tokyo (JP)

(21) Appl. No.: 14/668,226

(22) Filed: Mar. 25, 2015

(30) Foreign Application Priority Data
Oct. 28, 2014 (JP) 2014-219360

(51) Int. Cl. H01M 4/58; C01B 25/45; H01M 10/0525

(52) U.S. Cl. CPC H01M 4/5825; H01M 10/0525; C01B 25/45; H01M 2220/20; H01M 2220/30

(57) ABSTRACT

A cathode material including active material particles formed of a cathode active material, in which the cathode active material is LiₓA_{y}D_{z}PO₄ (here, A represents one or more metal elements selected from a group consisting of Fe, Co, Mn, Ni, Cu and Cr, D represents one or more metal elements selected from a group consisting of Mg, Ca, Sr, Ba, Ti, Zn, Ge, Sc, Y, and rare earth elements, 0<x≦2, 0<y≦1 and 0≦z<1.5), an average valence of the metal element represented by A and the metal element represented by D are in a range of 2 to 2.02, and a particle pH of the active material particles is in a range of 6.5 to 8.5.

### TECHNICAL FIELD

The present invention relates to a cathode material, a method of producing a cathode material, a cathode and a lithium ion battery.

### BACKGROUND ART

Studies regarding secondary batteries used in portable electronic devices and hybrid vehicles have been performed. Lead storage batteries, alkali storage batteries, lithium ion batteries and the like are known as typical secondary batteries. Among a variety of secondary batteries, lithium secondary batteries in which a lithium ion battery is used have advantages of high output, high energy density and the like.

As a cathode active material used for lithium ion batteries, phosphate which includes Li and transition metals and has an olivine structure has been known. For example, LiMPO₄ (M represents a transition metal) has been known as the above-described cathode active material. Examples of M which represents a transition metal include Mn and Fe.

With respect to such cathode active materials, there is a demand for improving a variety of performance depending on applications thereof. For example, with respect to lithium secondary batteries, there is a demand for improving the charge and discharge rate in order to improve the performance thereof. Regarding the aforementioned requirement, a method for synthesizing LiMPO₄ is known in which the charge and discharge rate is improved by adding Li or M in excess with respect to P to decrease the particle diameter thereof (for example, refer to Patent Document 1).

On the other hand, in order to improve performance, a method for removing impurities included in LiMPO₄ has been known in which cleaning of LiMPO₄ that is a cathode material is performed using a pH buffer (for example, refer to Patent Document 2). Due to the removal of impurities, effects such as an increase in the battery capacity and the suppression of internal short circuit can be anticipated, and the service life of lithium ion batteries can be extended.

### CONVENTIONAL ART

### Patent Document

Patent Document 1: International Publication No. WO2009/131095

Patent Document 2: Japanese Unexamined Patent Application, First Publication No. 2009-032656

### DISCLOSURE OF THE INVENTION

### Problem to be Solved by the Invention

It is needless to say that cathode active materials (cathode materials) containing no impurities are preferred. However, it has been difficult to measure the contents of small amounts of metal oxides derived from metals contained in the cathode material and the contents of small amounts of compounds such as Li₃PO₄ derived from Li or phosphorous. Therefore, when cathode active materials are not sufficiently cleaned, cycle characteristics and the extension of the service life are adversely affected. On the other hand, even when excessive cleaning is performed, such method was unsatisfactory from the view point of production efficiency, production costs or the like.

Meanwhile, in methods for decreasing impurities using a conventional method such as the above-described method, it has been difficult to decrease impurities to a level required by the market, and further improvements have been required from the view point of production efficiency, production costs and the like.

The present invention has been made in consideration of the above-described circumstances. An object of the present invention is to provide a cathode material which is capable of producing high-performance lithium ion batteries having a reduced amount of impurities. In addition, another object of the present invention is to provide a method for producing a cathode material in which cathode materials having a reduced amount of impurities can be easily produced. Still another object of the present invention is to provide a cathode which includes the above-described cathode material or a cathode material obtained using the above-described method for producing a cathode material and a lithium ion battery including the cathode.

### Means for Solving the Problem

In order to solve the above-described problem, as a first aspect of the present invention, there is provided a cathode material including active material particles formed of a cathode active material, in which the cathode active material is LiₓA_{y}D_{z}PO₄ (here, A represents one or more metal elements selected from a group consisting of Fe, Co, Mn, Ni, Cu and Cr, D represents one or more metal elements selected from a group consisting of Mg, Ca, Sr, Ba, Ti, Zn, Ge, Sc, Y and rare earth elements, 0<x≦2, 0<y≦1 and 0≦z<1.5), an average valence of the metal element represented by A and the metal element represented by D is in a range of 2 to 2.02, and a particle pH of the active material particles is in a range of 6.5 to 8.5.

According to the first aspect of the present invention, the cathode active material may be LiMnPO₄.

According to the first aspect of the present invention, the active material particles may have a carbonaceous material at surfaces thereof, and include an aggregate obtained by agglomerating the active material particles as primary particles.

As a second aspect of the present invention, there is provided a method of producing a cathode material including: preparing active material particles formed of a cathode active material, wherein the cathode active material is LiₓA_{y}D_{z}PO₄ (here, A represents one or more metal elements selected from a group consisting of Fe, Co, Mn, Ni, Cu and Cr, D represents one or more metal elements selected from a group consisting of Mg, Ca, Sr, Ba, Ti, Zn, Ge, Sc, Y and rare earth elements, 0<x≦2, 0<y≦1, and 0≦z<1.5), exposing the active material particles in an acidic environment having a pH in a range of 4.0 to 6.0, and obtaining the cathode material from the exposed active material particles.

As a third aspect of the present invention, there is provided a cathode including the above-described cathode material or a cathode material produced using the above-described method for producing a cathode material.

As a fourth aspect of the present invention, there is provided a lithium ion battery including the above-described cathode.

### Effects of the Invention

According to the present invention, it is possible to provide a cathode material capable of producing high-performance lithium ion batteries having a reduced amount of impurities, and excellent properties of such batteries can be guaranteed before lithium ion batteries are actually manufactured using the cathode material to measure properties thereof. The reason is that it is possible to reduce the amount of compounds included in a minute amount such as metal oxides, which are derived from metals, and Li PO₄, which is derived from Li and phosphorous, to an amount in a range in which no problem is caused regarding the performance of batteries. In addition, it is possible to provide a method for producing a cathode material which is capable of easily producing cathode materials having a reduced amount of impurities. Furthermore, it is possible to provide a cathode including the above-described cathode material or a cathode material obtained using the method for producing a cathode material, and a lithium ion battery including the cathode.

### BRIEF DESCRIPTION OF THE DRAWING

FIG. 1A is a schematic view illustrating an example of a cathode and a lithium ion battery according to the present embodiment.

FIG. 1B illustrates an example of a lithium ion battery according to the present embodiment.

### BEST MODE FOR CARRYING OUT THE INVENTION

Cathode Material

A cathode material of the present embodiment includes active material particles which are formed from a cathode active material, wherein the cathode active material is LiₓA_{y}D_{z}PO₄ (here, A represents one or more metal elements selected from a group consisting of Fe, Co, Mn, Ni, Cu and Cr, D represents one or more metal elements selected from a group consisting of Mg, Ca, Sr, Ba, Ti, Zn, Ge, Sc, Y and rare earth elements, 0<x≦2, 0<y≦1, and 0≦z<1.5), the average valence of the metal element represented by A and the metal element represented by D is in a range of 2 to 2.02, and the particle pH of the active material particles is in a range of 6.5 to 8.5.

The rare earth elements refer to 15 elements of La, Ce, Pr, Nd, Pm, Sm, Eu, Gd, Tb, Dy, Ho, Er, Tm, Yb and Lu which belong to the lanthanum series.

Here, A is preferably Co, Mn, Ni or Fe, and more preferably Mn. D is preferably Mg, Ca, Sr, Ba, Ti or Zn. In a case in which the cathode active material includes the above-described elements, it is possible to produce cathode materials capable of realizing a high discharge potential and high safety. In addition, the above-described elements have abundant resources, and thus are preferred as selective materials.

In the cathode material of the present embodiment, the cathode material is preferably LiMnPO₄.

In the cathode material of the present embodiment, the cathode active material has a particle shape. In the present specification, particles formed of the cathode active material will be referred to as “active material particles”.

The size of the active material particle is not particularly limited, and the average particle diameter of the primary particles thereof is preferably in a range of 0.01 μm to 2 μm, and more preferably in a range of 0.02 μm to 0.5 μm.

When the average particle diameter of the primary particles of the active material particles is 0.01 μm or more, it is possible to sufficiently coat the surfaces of the primary particles with the carbonaceous film, the discharge capacity at a high-speed charge and discharge rate is not easily decreased, and it becomes possible to realize sufficient charge and discharge rate performance, which are preferable.

On the other hand, when the average particle diameter of the primary particles of the active material particles is 2 μm or less, there is no case in which the internal resistance of the primary particles becomes excessively high, and therefore the discharge capacity at a high-speed charge and discharge rate can be sufficiently ensured, which are preferable.

The shape of the active material particle is not particularly limited, but is preferably spherical, and truly spherical is particularly preferable.

When the shapes of the active material particles are spherical, it is possible to reduce the amount of a solvent when paste for forming cathodes is prepared by mixing the active material particles, a binder resin (binder) and the solvent, and it is possible to apply the paste easily to a collector for forming cathodes, which are preferable.

In addition, when the shapes of the active material particles are spherical, the surface area of the active material particles is minimized, and it is possible to set the blending amount of the binder resin (binder) added to the cathode material to the minimum amount. When the amount of the binder resin added is decreased, it is possible to decrease the internal resistance of the obtained cathode, which is preferable.

Furthermore, when the shapes of the active material particles are spherical, it is easy to achieve close-pack of the active material particles, and thus the amount of the cathode material loaded per unit volume increases. As a result, it is possible to increase the electrode density, and it is possible to increase the capacity of the lithium ion battery, which are preferable.

The active material particle preferably has a carbonaceous material on the surface thereof. Here, the carbonaceous material refers to a carbon simple substance or a carbon material including carbon as a main component.

“Having the carbonaceous material on the surface thereof” means to have any one or more states of:

(i) a state in which the surfaces of the active material particles are coated with a coating (carbonaceous film) made of a carbonaceous material,

(ii) a state in which a plurality of particles made of a carbon simple substance or particles made of a carbon material including carbon as a main component is attached or bonded to the surfaces of the active material particles, and

(iii) a state in which a plurality of aggregates formed by agglomerating a plurality of particles made of a carbon simple substance or particles made of a carbon material including carbon as a main component are attached or bonded to the surfaces of the active material particles.

Hereinafter, in some cases, “the active material particles having a carbonaceous material on the surface thereof” exhibiting the (i) to (iii) states may be referred to as composite particles.

The above-described states may include states in which one or more kinds of particles and/or aggregates are present between the composite particles, wherein they are selected from particles made of a carbon simple substance, particles made of a carbon material including carbon as a main component, and aggregates formed by agglomerating a plurality of the aforementioned particles.

The coating ratio (cover ratio) of the carbonaceous material regarding the surfaces of the active material particles is preferably 60% or more, and more preferably 80% or more. The coating ratio can be measured using a transmission electron microscope (TEM), an energy dispersive X-ray spectrometer (EDX) or the like.

When the coating ratio of the carbonaceous material is 60% or more, it becomes possible to uniformly cause reactions of the intercalation and deintercalation of lithium ions throughout all the surfaces of the active material particles when the cathode material of the present embodiment is used as a material for lithium ion batteries, and therefore the ratio is preferable.

When the coating ratio provided by the carbonaceous material is 60% or more, moisture is not easily adsorbed to the surfaces of the active material particles.

Therefore, it is possible to suppress disadvantages, which cause the breakage of batteries, such as deterioration of battery components which is caused by hydrofluoric acid generated by a reaction between moisture and an electrolyte and an increase in the internal pressure of battery packages which is caused by the generation of gas due to the decomposition of water during charging and discharging.

The content of oxygen in the carbonaceous material of the composite particle is preferably 5.0% by mass or less, and more preferably 3.0% by mass or less.

“The content of oxygen” refers to the amount (% by mass) of oxygen atoms included in the entire carbonaceous material. In the carbonaceous material, oxygen atoms are included in forms of a functional group such as a hydroxyl group, a carbonyl group, a carboxyl group, an ether bond and an ester bond (hereinafter, in some cases, will be referred to as ‘the oxygen-containing functional group’).

The content of oxygen can be obtained by the method comprising: dissolving the cathode active material included in the composite particles to a hydrochloric acid solution so as to obtain a carbonaceous material as an individual material, then, cleaning the carbonaceous material using pure water, drying the carbonaceous material at 100° C. for two hours in a vacuum, and measuring the amount of oxygen in the obtained dried substance using an oxygen and nitrogen analyzer.

When the carbonaceous material has an oxygen-containing functional group, there is a concern that the internal pressure of battery packages may be increased due to gas generated from the oxygen-containing functional group during charging, and batteries may be broken. However, when the content of oxygen in the carbonaceous material is 5.0% by mass or less, the amount of generated gas can be suppressed, and the breakage of batteries is easily suppressed, which are preferable.

When the content of oxygen in the carbonaceous material is 5.0% by mass or less, the amount of moisture which may be adsorbed to the oxygen-containing functional group of the carbonaceous material decreases. Therefore, it is possible to suppress the deterioration of battery components which is caused due to hydrofluoric acid generated by a reaction between moisture and an electrolyte, which is preferable.

The specific surface area of the composite particle is preferably in a range of 1 m²/g to 80 m²/g, and more preferably in a range of 4 m²/g to 50 m²/g.

When the specific surface area of the composite particle is 1 m²/g or more, it does not take a long period of time for lithium ions or electrons to migrate in the composite particles, the internal resistance does not easily increase, and the deterioration of the output characteristics can be suppressed, which are preferable.

On the other hand, when the specific surface area of the composite particle is 80 m²/g or less, the amount of carbon included in the entire cathode material does not become excessive, and it is possible to suppress a decrease in the charge and discharge capacity of the entire cathode material, which are preferable.

“The internal resistance” mentioned herein refers to, mainly, the sum of electron resistance and lithium ion migration resistance. The electron resistance is proportional to the amount of carbon, the density of carbon and the crystallinity of carbon. The lithium ion migration resistance is inversely proportional to the amount of carbon, the density of carbon and the crystallinity of carbon.

As a method for evaluating the internal resistance, for example, a current-rest method or the like is used. In the current-rest method, the internal resistance is measured as the sum of: wiring resistance, contact resistance, charge migration resistance, lithium ion migration resistance, lithium reaction resistance at the cathode and anode, interelectrode resistance determined by the distance between the cathode and anode, resistance regarding the solvation and desolvation of lithium ions, and the solid electrolyte interface (SEI) migration resistance of lithium ions.

The content of carbon included in the composite particles is preferably in a range of 0.3% by mass to 8.0% by mass, and more preferably in a range of 0.5% by mass to 5.0% by mass.

When the content of carbon included in the composite particles is 0.3% by mass or more, the discharge capacity does not easily decrease at a high charge-discharge rate in a case in which batteries are formed, and it becomes possible to realize sufficient charge and discharge rate performance, which are preferable.

When the content of carbon included in the composite particles is 8.0% by mass or less, the migration distance of lithium ions in carbon in which the diffusion rate of lithium ions is slow does not become excessively long, and thus it becomes possible to suppress a voltage drop at a high charge-discharge rate to an ignorable level, which are preferable.

In the cathode active material represented by LiₓA_{y}D_{z}PO₄ of the cathode material of the present embodiment, the average valence of all of the metal elements which comprise the metal element represented by A and the metal element represented by D (hereinafter, referred to simply as “all the metal elements”) is in a range of 2 to 2.02.

When the average valence of all of the metal elements which comprise the metal element represented by A and the metal element represented by D is 2, all the metal element represented by A and the metal element represented by D included in the cathode active material form a desired compound. In this case, it becomes possible to realize a large charge and discharge capacity, which is most preferable. Meanwhile, in order to obtain a cathode active material capable of realizing a high speed charge-discharge rate, as described below, it is necessary to adjust the pH of a synthetic dispersion liquid to a weak acid in order to reduce the size of the cathode active material. The adjustment of the pH to a weak acid may generate an extremely small amount of impurities. However, when the average valence of all the metal elements is 2.02 or less, it is possible to realize a sufficient charge and discharge capacity.

In the present invention, regarding the “average valence of all the metal elements”, evaluation of the valence of the obtained active material was performed using iodometry. The iodometry was performed such that the active material was dissolved in 20 mL of 17% hydrochloric acid in which lithium iodide which was approximately 10 times of the active material (mass: 40 mg to 50 mg) has been dissolved, and was titrated using a sodium thiosulfate solution calibrated using 99.9% Mn₂O₃, thereby obtaining the valence.

In the cathode material of the present embodiment, the particle pH of the active material particle thereof is in a range of 6.5 to 8.5. When the particle pH is 6.5 or more, a cleaning fluid having a pH in a range of 4.0 to 6.0 can be removed, which is preferable. When the particle pH is 8.5 or less, although impurities such as Li₃PO₄ derived from Li or phosphorous may remain, the influence of the amount of the impurities on battery performance is small, and high-performance lithium ion batteries can be produced, which is preferable.

In the present invention, the particle pH of the active material particles was measured as described below.

5 g of the active material particles were mixed and stirred in 50 g of pure water at 25° C., and were left to stand for 10 minutes. After that, the active material particles were mixed by stirring again, and were left to stand for 10 minutes. Then, pH as the particle pH of the obtained supernatant solution was measured using a pH meter D-51 manufactured by Horiba Ltd.

According to the above-described cathode material of the present embodiment, cathode material capable of producing high-performance lithium ion batteries can be obtained. The reason is that, due to the present invention, the content of metal oxides derived from metals and the content of compounds such as Li₃PO₄ derived from Li and/or phosphorous, which are included in a minute amount and are difficult to measure, can be reduced to a value included in a range wherein no problem is caused regarding the performance of batteries, and therefore it is not necessary to form the lithium ion batteries only for measuring actual properties thereof.

Method for Producing Cathode Material

The cathode material of the present embodiment can be produced by exposing the above-described active material particles in an acidic environment having a pH which is in a range of 4.0 to 6.0.

An active material precursor is synthesized as described below.

First, the dispersion liquid obtained by dispersing a lithium salt, a metal salt containing A, a metal salt containing D or a compound containing D, and a phosphate compound in a dispersion medium is prepared.

Examples of the lithium salt include lithium acetate (LiCH₃COO), lithium chloride (LiCl), lithium hydroxide (LiOH) and the like.

As the metal salt containing A, it is possible to use a divalent halide, sulfate, nitrate, acetate or the like.

As the metal salt containing D, it is possible to use a divalent halide, sulfate, nitrate, acetate or the like.

As the compound containing D, it is possible to use magnesium sulfate, calcium chloride, barium acetate, titanium nitrate or the like.

Examples of the phosphoric acid compound include phosphoric acid (H₃PO₄), ammonium dihydrogen phosphate (NH₄H₂PO₄), diammonium hydrogen phosphate ((NH₄)₂HPO₄) and the like.

Each component may be used singly, or two or more kinds of the element may be used in combination.

As the dispersion medium, it is possible to use, for example, water, a polar organic solvent such as alcohols, ethers, acetonitrile, tetrahydrofuran and dimethyl sulfoxide, a solution mixture thereof, liquefied gas or the like. While there is no particular limitation, water is preferably used since the environmental load is small, and water is cheap and safe. In addition, since water shows a large change in permittivity (dielectric constant) near the critical point, it is possible to easily control solvent properties such as solubility of individual substances by adjusting temperature and pressure, and the reaction conditions are easily controlled.

In the dispersion liquid, the mixing ratio of a lithium salt, a metal salt containing A, a metal salt containing D or a compound containing D and a phosphate compound is preferably set such that the lithium salt is used in an excessive molar ratio, and the total mole of A and D and the mole of the phosphate compound is equal. Specifically, the ratio thereof shown by the lithium salt:the sum of A and D:the phosphate compound is most preferably 2.5 to 3.5:1:1.

In addition, the pH of the dispersion liquid is preferably in a range of 5.2 to 6.5. In this range, while impurities may be generated, it is possible to synthesize active material particles in which the primary particles thereof are fine and have high crystallinity, and sufficient discharge capacity can be ensured at a high speed charge-discharge rate.

In a pH range lower than 5.2, the metal element represented by A and the metal element represented by D may be oxidized, and thus the oxides of these elements may be slightly generated as impurities. An impurity which is triphosphate lithium derived from phosphoric acid tends to be mainly generated. As the pH increases, a greater amount of the impurities are generated. In a pH range higher than 6.5, a great amount of impurities are generated, and thus a sufficient discharge capacity cannot be ensured.

Next, the prepared dispersion liquid is put into a pressure resistant vessel, is heated to a predetermined temperature, and is reacted for a predetermined period of time (hydrothermal reaction).

The reaction conditions are appropriately selected depending on the kind of the solvent and substance being synthesized. In a case in which water is used as the solvent, the heating temperature is preferably in a range of 80° C. to 900° C., and the reaction time is preferably in a range of 0.5 hours to 24 hours. When the reaction is caused in a sealed pressure resistant vessel, the pressure during the reaction is in a range of 0.1 MPa to 100 MPa. In a case in which the solvent is water, the heating temperature is preferably in a range of 80° C. to 374° C., and the pressure during the reaction is in a range of 0.1 MPa to 22 MPa. The heating temperature is more preferably in a range of 100° C. to 350° C., the reaction time is more preferably in a range of 0.5 hours to 5 hours, and the pressure during the reaction is more preferably in a range of 0.1 MPa to 17 MPa.

The size of the active material particle is not particularly limited. The average particle diameter of the primary particles is preferably in a range of 0.01 μm to 2 μm, and more preferably in a range of 0.02 μm to 0.5 μm.

When the average particle diameter of the primary particles of the active material particles is 0.01 μm or more, it is possible to sufficiently cover the surfaces of the primary particles with the carbonaceous film, the discharge capacity at a high-speed charge and discharge rate is not easily decreased, and it becomes possible to realize sufficient charge and discharge rate performance, which are preferable.

On the other hand, when the average particle diameter of the primary particles of the active material particles is 2 μm or less, there is no case in which the internal resistance of the primary particles becomes excessively high, and the discharge capacity at a high-speed charge and discharge rate can be sufficiently ensured, which are preferable.

The particle shape of the active material particle is not particularly limited. The particle shape of the active material particle is often formed according to the production method. For example, spherical particles are likely to be obtained when the active material particles are produced using a solid-phase method, and rectangular particles or rod-like particles are likely to be obtained when the active material particles are produced using a hydrothermal synthesis method. Individual particles have their own good characteristics as follow. Spherical particles have an excellent filling property, rectangular particles have an excellent lithium ion intercalation and deintercalation reactivity, and rod-like particles allow easy contact between the particles and thus have excellent electron conductivity. Therefore, the spherical particles, the rectangular particles and the rod-like particles may be singly used, or a mixture of two or more kinds of the particles may be used.

Cleaning Next, the obtained active material particles are exposed in an acidic environment having a pH 4.0 to 6.0 to remove impurities by cleaning. The exposure of the active material particles to an acidic environment may be performed such that a reaction product (active material particles) which is obtained by the aforementioned hydrothermal reaction is separated by the filtration and then the separated reaction product is cleaned using a cleaning fluid having a pH which is in a range of 4.0 to 6.0, or an acid is added to the slurry obtained after the hydrothermal reaction so as to set the pH of the slurry in a range of 4.0 to 6.0.

When the pH of the acidic environment to which the active material particles are exposed is 4.0 or higher, the target product which is LiₓA_{y}D_{z}PO₄ is not easily dissolved, and the yield thereof is not easily decreased. In addition, protons do not easily exchange each other between Li and H included in the crystals, and thus favorable battery characteristics can be developed, which is preferable.

When the pH of the acidic environment to which the active material particles are exposed is 6.0 or lower, favorable battery characteristics can be developed since a desired impurity-cleaning effect can be sufficiently obtained, and furthermore, the oxidation of LiₓA_{y}D_{z}PO₄ is suppressed, and therefore such condition is preferable.

When the active material particles are exposed in the acidic environment for approximately 10 minutes, it is possible to sufficiently obtain a desired impurity-cleaning effect.

Regarding the types of the usable acid, hydrochloric acid, sulfuric acid, nitric acid, phosphoric acid, acetic acid, citric acid or the like can be used.

The concentration of the acid is preferably relatively low, and is preferably in a range of approximately 0.05 N to 0.15 N.

Spraying and Drying of Slurry

Next, the above-described active material particles, an organic compound and the solvent are mixed together so as to prepare a slurry. In a case in which the coat of the carbonaceous material is not formed on the surfaces of the active material particles, the organic compound may not be used.

Examples of the organic compound include vinyls such as polyvinyl alcohol, polyvinyl pyrrolidone and polyvinyl acetate; celluloses such as cellulose, carboxymethyl cellulose, methyl cellulose, hydroxylmethyl cellulose and hydroxyethyl cellulose; sugars such as glucose, fructose, galactose, mannose, maltose, sucrose and lactose; starch, gelatin, polyacrylic acid, polystyrene sulfonate, polyacrylamide, glycogen, pectin, alginic acid, glucomannan, chitin, hyaluronic acid, chondroitin, agarose, polyether, divalent alcohols such as ethylene glycol, trivalent alcohols such as glycerin, and the like.

Regarding the mixing ratio between the cathode active material and the organic compound, when the total amount of the organic compound is converted to the carbon amount (carbon content), the amount of the organic compound is preferably in a range of 0.6 to 10 parts by mass, and more preferably in a range of 0.8 parts by mass to 2.5 parts by mass with respect to 100 parts by mass of the cathode material.

When the mixing ratio of the organic compound which is converted into the carbon amount is 0.6 parts by mass or more, the coating ratio of the carbonaceous film does not easily drop below 80%. Therefore, in a case in which a battery is formed using the cathode material which is obtained from the prepared slurry, the discharge capacity at a high charge-discharge rate does not easily decreases, and it becomes possible to realize sufficient charge and discharge rate performance, which is preferable.

On the other hand, when the mixing ratio of the organic compound which is converted into the amount of carbon is 10 parts by mass or less, in a case in which a battery is formed using the cathode material which is obtained from the slurry, the ratio of the coating layer does not become excessively high, and the amount of the cathode active material can be ensured, and thus it is possible to suppress a decrease in the battery capacity. In addition, it is possible to suppress a decrease in the electrode density and suppress a decrease in the battery capacity of a lithium ion battery per unit volume.

During the preparation of the slurry, a dispersant may be added as necessary.

Water is most suitably used as a solvent in terms of easy procurement (availability), easy handling, and low production costs. In addition, a liquid mixture of water and a solvent having a different boiling point from water may be used.

As the solvent having a different boiling point from water, it is possible to use one or a mixture of two or more selected from the group monovalent alcohols such as methanol (boiling point: 64.1° C./at 1 atmosphere), ethanol (boiling point: 78.3° C./at 1 atmosphere) and 2-propanol (boiling point: 82.4° C./at 1 atmosphere); divalent alcohols such as ethylene glycol (boiling point: 197° C./at 1 atmosphere); trivalent alcohols such as glycerin (boiling point: 290° C./at 1 atmosphere), sugar alcohols, phenols, cycloparaffin-based hydrocarbons (cycloalkane), cycloolefin-based hydrocarbons (cycloalkene), cycloacetylene-based hydrocarbons (cycloalkyne), benzene-based aromatic compounds, condensed-ring aromatic compounds, benzo condensed-ring compounds, heteroaromatic compounds, and non-benzene-based aromatic compounds.

The method for dissolving or dispersing the cathode active material and the organic compound in the solvent is not particularly limited as long as the cathode active material can be dispersed, and the organic compound can be dissolved and/or dispersed. It is preferable to use, for example, a medium stirring-type dispersion apparatus that stirs medium particles at a high speed such as a planetary ball mill, an vibration ball mill, a bead mill, a paint shaker or an attritor.

When the dissolution and/or dispersion are performed, it is preferable to disperse the cathode active material as a primary particle, and then add and stir the organic compound so as to be dissolved. Then, the surfaces of the primary particles of the cathode active material are coated with the organic compound, and consequently, carbon derived from the organic compound is uniformly interposed between the primary particles of the cathode active material.

In the preparation of the slurry, regarding the cumulative volume percentage in the particle size distribution of the positive electrode active material or the precursor in the slurry, conditions are preferably controlled so that the ratio (D90/D10) of the particle diameter at 90% (D90) to the particle diameter at 10% (D10) falls in a range of 5 to 30. The dispersion conditions of the slurry can be adjusted using, for example, the concentration of the cathode active material or the precursor thereof in the slurry, the concentration of the organic compound, the stirring speed, the stirring time and the like. Due to the above condition, the particle size distribution of the cathode active material or the precursor thereof in the slurry becomes wide, and thus the cathode active material is closely packed in an aggregate obtained by spraying and drying the slurry, and it is possible to realize a volume density of the aggregate which is in a range of 50% by volume to 80% by volume.

Next, the slurry is generally sprayed and dried in a high-temperature atmosphere in which the atmospheric temperature is equal to or higher than the boiling point of the solvent, for example, in the atmosphere at a temperature in a range of 70° C. to 250° C.

A dried substance having an average particle diameter in a range of 0.5 μm to 100 μm, preferably in a range of 0.5 μm to 20 μm, can be obtained, when conditions are appropriately adjusted wherein the conditions may include the spraying conditions such as the respective concentrations of the cathode active material or the precursor thereof and of the organic compound in the slurry, the spraying pressure and the spraying speed, and the drying conditions after the spraying such as the temperature increase rate, the peak holding temperature, the holding time and the like.

The atmospheric temperature during the spraying and the drying affects the evaporation speed of the solvent in the slurry, and thus the structure of the obtained dried substance can be controlled.

For example, as the atmospheric temperature becomes closer to the boiling point of the solvent in the slurry, a longer period of time is taken to dry the sprayed droplets, and thus the obtained dried substance sufficiently contracts during a period of time necessary for the droplets to be dried. Therefore, the dried substance sprayed and dried at an atmospheric temperature close to the boiling point of the solvent in the slurry does not easily have a hollow structure.

On the other hand, when the slurry is sprayed and dried at an atmospheric temperature significantly higher than the boiling point of the solvent in the slurry, the sprayed liquid droplets are dried in a moment, and thus the fluidity of the slurry significantly degrades. Therefore, the obtained dried substance is dried in a moment, and thus a sufficient amount of time for the dried substance to contract is not provided. Therefore, the dried substance sprayed and dried at an atmospheric temperature higher than the boiling point of the solvent in the slurry easily obtains a hollow structure. Furthermore, it is possible to obtain a single-peak pore size distribution of micropores present in the aggregate, and it is possible to set the average micropore diameter of the aggregate to 0.3 μm or less.

Firing

Next, the dried substance is fired in a non-oxidizing atmosphere at a temperature in a range of 500° C. to 1000° C., preferably in a range of 600° C. to 900° C., for 0.1 hours to 40 hours.

The non-oxidizing atmosphere is preferably an inert atmosphere of nitrogen (N₂), argon (Ar) or the like, and in a case in which it is necessary to further suppress oxidization, a reducing atmosphere including approximately several % by volume of a reducing gas such as hydrogen (H₂) is preferred. In addition, in order to remove organic components evaporated in the non-oxidizing atmosphere during the firing, it is also possible to introduce combustion-enhancing or burnable gases such as oxygen (O₂) into the inert gas atmosphere.

When the firing temperature is 500° C. or higher, the organic compound contained in the dried substance is sufficiently decomposed and reacted, and thus the organic compound is sufficiently carbonized, and consequently, the high-resistance decomposed substance of the organic compound does not easily remain in the obtained aggregate, which is preferable.

On the other hand, when the firing temperature is 1000° C. or lower, Li in the cathode active material does not easily evaporate, and thus the composition of the cathode active material does not easily deviate, and grains of the cathode active material do not easily grow. As a result, the discharge capacity at a high charge-discharge rate does not easily decrease, and sufficient charge and discharge rate performance can be realized, which are preferable.

Through the above-described steps, the cathode material of the present embodiment can be produced.

Cathode and Lithium Ion Battery

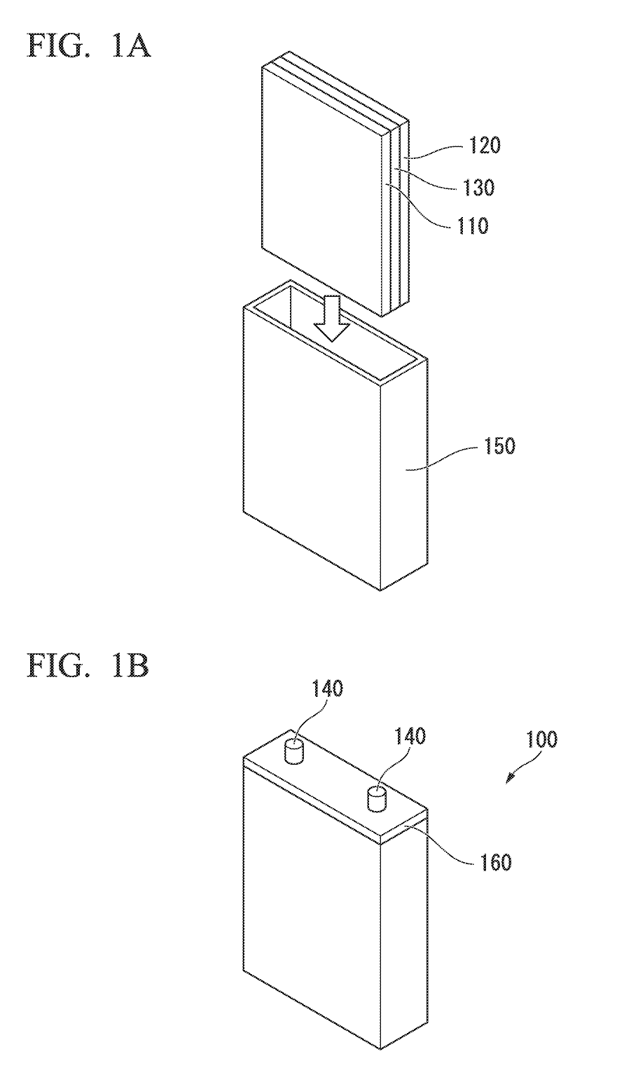

FIG. 1 is a schematic view illustrating an example of the cathode and the lithium ion battery according to the present embodiment. The drawing illustrates a square lithium ion battery 100. The lithium ion battery 100 includes a cathode 110, a anode 120, a separator 130, terminals 140, a housing 150 and a lid 160. The lithium ion battery 100 has a so-called laminated constitution.

The cathode 110 is the cathode according to the present embodiment, and includes the above-described cathode material or a cathode material produced using the above-described method of producing the cathode material. The drawing illustrates members having a square shape when seen in a planar view.

In order to produce the cathode of the present invention, coating material for forming the cathode or paste for forming the cathode is prepared by mixing the above-described cathode material or a cathode material produced using the above-described method of producing the cathode material, a binder made of a binder resin and a solvent. At this time, a conductive auxiliary agent such as carbon black may be added as necessary.

As the binder, that is, the binder resin, for example, a polytetrafluoroethylene (PTFE) resin, a polyvinylidene fluoride (PVdF) resin, fluororubber or the like is preferably used.

The blending ratio between the cathode material and the binder resin is not particularly limited, and for example, the amount of the binder resin is set in a range of 1 to 30 parts by mass, preferably in a range of 3 to 20 parts by mass, with respect to 100 parts by mass of the cathode material.

Examples of the solvent used in the coating material for forming the cathode or the paste for forming the cathode include water; alcohols such as methanol, ethanol, 1-propanol, 2-propanol (isopropyl alcohol: IPA), butanol, pentanol, hexanol, octanol and diacetone alcohol; esters such as ethyl acetate, butyl acetate, ethyl lactate, propylene glycol monomethyl ether acetate, propylene glycol monoethyl ether acetate and γ-butyrolactone; ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether and diethylene glycol monoethyl ether; ketones such as acetone, methyl ethyl ketone (MEK), methyl isobutyl ketone (MIBK), acetylacetone and cyclohexanone; amides such as dimethyl formamide, N,N-dimethyl acetamide and N-methyl pyrrolidone; glycols such as ethylene glycol, diethylene glycol and propylene glycol; and the like. These solvents may be singly used, or a mixture of two or more solvents may be used.

Next, the coating material for forming the cathode or the paste for forming the cathode is applied to one surface of a metal foil, and is dried, thereby obtaining a metal foil having a coating made of a mixture of the cathode material and the binder resin which is formed on one surface of the metal foil.

Subsequently, the coating is bonded to the metal foil by pressurization, and is dried, thereby producing a collector (cathode) having a cathode material layer on one surface of the metal foil.

In this way, the cathode of the present embodiment can be produced.

The anode 120 is illustrated in the figure as a member having a square shape when seen in a planar view. As the anode 120, it is possible to use an anode that is generally known to be used as a anode for lithium ion batteries. For example, it is possible to use an anode produced using a anode material such as metallic Li, a carbon material, a Li alloy or Li₄Ti₅O₁₂.

The separator 130 has functions of preventing the short circuit between the cathode 110 and the anode 120 and holding an electrolyte due to impregnation. As the separator 130, it is possible to use a separator that is generally known to be used as a separator for lithium ion batteries.

In the lithium ion battery 100, the terminals 140 are respectively connected to the cathode 110 and the anode 120, and electrically connect the electrodes to an external device.

The housing 150 accommodates the cathode 110, the anode 120, the separator 130 and the electrolyte, and is capable of employing a variety of shapes on the basis of the standards of batteries, for example, a cylindrical shape in addition to the square shape illustrated in the drawing.

The lid 160 seals the housing 150, and has the terminals 140 attached thereto.

The above-described lithium ion battery 100 can be produced by, first, providing the separator 130 between the cathode 110 and the anode 120, accommodating the components in the housing 150 (FIG. 1A), impregnating the separator 130 with the electrolyte so as to dispose an electrolyte between the cathode 110 and the anode 120, and sealing the housing 150 using the lid 160 having the terminals 140 respectively connected to the cathode 110 and the anode 120 (FIG. 1B).

In the figure, a set of the cathode 110, the anode 120 and the separator 130 is accommodated in the housing 150, but it is also possible to alternatively dispose a plurality of cathodes and a plurality of anodes, and dispose separators between each combination of the respective cathodes and the respective anodes, thereby forming a multilayer laminated type constitution.

In addition, instead of the electrolyte and the separator 130, a solid electrolyte may be used.

According to the cathode having the above-described constitution, a high-performance cathode can be produced, since the cathode material of the present embodiment is included.

In addition, according to the lithium ion battery having the above-described constitution, a high-performance lithium ion battery can be obtained, since the cathode of the present embodiment is included.

Thus far, the preferred embodiments according to the present invention have been described with reference to the accompanying drawings, and it is needless to say that the present invention is not limited to the examples. The shapes, combinations and the like of the respective components described in the aforementioned examples are examples, and a variety of modifications based on design requirements and the like are allowed within the scope of the purpose of the present invention.

### EXAMPLES

Hereinafter, the present invention will be described using examples, but the present invention is not limited to the examples.

For cathode materials produced in examples and comparative examples below, the following measurements were carried out.

(1) Measurement of Average Valence

Regarding the average valence, evaluation of the valence of the obtained active material was performed by iodometry. In the iodometry, the valence was obtained such that the active material was dissolved in 20 mL of 17% hydrochloric acid which was obtained by dissolving lithium iodide as much as approximately 10 times the mass of the active material (40 mg to 50 mg), and was titrated using a sodium thiosulfate solution calibrated using 99.9% Mn₂O₃.

(2) Measurement of Particle pH

The particle pH was measured as follows. 5 g of the active material particles were stirred in 50 g of pure water at 25° C., and were left to stand for 10 minutes. After that, the active material particles were stirred again, were left to stand for 10 minutes, and the particle pH of the obtained supernatant solution was measured using a pH meter D-51 manufactured by Horiba Ltd.

(3) Measurement of Specific Surface Area

The specific surface area (m²/g) of the cathode material was measured using a specific surface meter (Belsorp II, manufactured by BEL Japan, Inc.).

### Example 1

6 mol of lithium acetate (LiCH₃COO), 2 mol of manganese (II) sulfate (MnSO₄) and 2 mol of phosphoric acid (H₃PO₄) were mixed with 2 liters of water, thereby preparing a raw material slurry.

Next, water was added so that the total amount of the raw material slurry reached 4 liters, thereby preparing a slurry-form mixture.

Next, the mixture was accommodated in a pressure resistant vessel having a capacity of 8 L to perform hydrothermally synthesis at 110° C. for 4 hours.

The obtained reaction product was sufficiently washed with distilled water plural times, and was dispersed in water, thereby producing a dispersion liquid including 20% by mass of LiMnPO₄. Next, 5% by mass of sulfuric acid was added to LiMnPO4, and the pH of the dispersion liquid after the addition of the sulfuric acid was 4.75.

Next, the dispersion liquid was stirred at 25° C. and a rotation rate of 150 rpm for 3 hours, then, was filtered using a filter, and the filtered solid was sufficiently washed with distilled water plural times, thereby obtaining LiMnPO₄ having a water content of 30%. The yield of the solid content of LiMnPO₄ in the washing operation was 97.4%.

Next, a 10% by mass aqueous solution of polyvinyl alcohol was added to the LiMnPO₄ so that the mass of polyvinyl alcohol was 5 parts by mass and the solid content of LiMnPO₄ was 95 parts by mass, and furthermore, water was added, thereby producing dispersion liquid wherein the total solid content was 20% by mass.

Then, granulating and drying of the dispersion liquid was performed using a spray dryer ADL311-A manufactured by Yamato Scientific Co., Ltd. at an inlet temperature of 180° C., and then, a thermal treatment was carried out at 600° C. for 1 hour, thereby obtaining a cathode material of Example 1.

The average valence of the cathode material was 2.012, and the particle pH was 7.32.

Production of Cathode

The obtained cathode material, polyvinylidene fluoride (PVdF) as a binder and acetylene black (AB) as a conductive auxiliary agent were mixed together so that the mass ratio thereof was 80:10:10, and furthermore, N-methyl-2-pyrrolidone (NMP) was added as a solvent so as to impart fluidity, thereby producing cathode material paste.

Next, the paste was applied on a 30 μm-thick aluminum (Al) foil, and was dried. After that, the aluminum foil was pressurized at a pressure of 30 MPa to obtain a cathode plate.

Next, the cathode plate was punched to a disc shape having a diameter of 16 mm using a forming machine, thereby producing a cathode for testing.

Production of Lithium Ion Battery

Lithium metal was used as a anode and the lithium ion battery was used as the cathode. A porous polypropylene film was disposed as a separator between the electrodes.

Meanwhile, ethylene carbonate and diethyl carbonate were mixed together at a ratio of (a mass ratio of) 1:1, and furthermore, 1 mol/L of a LiPF₆ solution was added, thereby producing an electrolyte solution having lithium ion conductivity.

Next, the cathode, the separator and the anode were sequentially laminated using a 2032 coin type cell, and the electrolyte solution was soaked into the separator, thereby producing a lithium ion battery of Example 1.

Evaluation of Lithium Ion Battery

The lithium ion battery was charged at an environmental temperature of 25° C. with a charging current of 0.1 CA so that the potential of the cathode reached 4.5 V with respect to the equilibrium potential of Li, was rested for 1 minute, and then the battery was discharged to 2.0 V at a discharge current of 1 CA.

The 1C discharge capacities at the 1^{st} cycle and the 300^{th} cycle are described in Table 1.

### Example 2

A cathode material, a cathode and a lithium ion battery of Example 2 were obtained in the same manner as in Example 1, except that the amount of sulfuric acid added was changed so that the pH of the dispersion liquid obtained after the addition of sulfuric acid was set to 4.11.

### Example 3

A cathode material, a cathode and a lithium ion battery of Example 3 were obtained in the same manner as in Example 1, except that the amount of sulfuric acid added was changed so that the pH of the dispersion liquid obtained after the addition of sulfuric acid was set to 5.87.

### Comparative Example 1

A cathode material, a cathode and a lithium ion battery of Comparative Example 1 were obtained in the same manner as in Example 1, except that the amount of sulfuric acid added was changed so that the pH of the dispersion liquid obtained after the addition of sulfuric acid was set to 6.89.

### Comparative Example 2

A cathode material, a cathode and a lithium ion battery of Comparative Example 2 were obtained in the same manner as in Example 1, except that the amount of sulfuric acid added was changed so that the pH of the dispersion liquid obtained after the addition of sulfuric acid was set to 9.27.

### Comparative Example 3

A cathode material, a cathode and a lithium ion battery of Comparative Example 3 were obtained in the same manner as in Example 1, except that the amount of sulfuric acid added was changed so that the pH of the dispersion liquid obtained after the addition of sulfuric acid was set to 3.14.

The evaluation results are described in Table 1 below.

TABLE 1

| | | | | | | 1 CA charge and | | |
|---|---|---|---|---|---|---|---|---|
| | | | Specific | | | discharge capacity | | |
| | pH of liquid | | surface | | | (mAh/g) | | |
| | prepared | Yield | area | Average | Particle | (A) 1^{st} | (B) 300^{th} | (B)/ |
| | for cleaning | (%) | (m²/g) | valence | pH | cycle | cycle | (A) |
| Example 1 | 4.75 | 97.4 | 29.9 | 2.012 | 7.32 | 138 | 129 | 0.93 |
| Example 2 | 4.11 | 96.3 | 31.2 | 2.003 | 6.64 | 131 | 118 | 0.90 |
| Example 3 | 5.87 | 97.6 | 33.1 | 2.018 | 8.41 | 126 | 116 | 0.92 |
| Comparative | 6.89 | 96.9 | 35.1 | 2.039 | 9.32 | 129 | 91 | 0.71 |
| Example 1 | | | | | | | | |
| Comparative | 9.27 | 94.7 | 30.9 | 2.091 | 10.57 | 118 | 77 | 0.65 |
| Example 2 | | | | | | | | |
| Comparative | 3.14 | 49.8 | 20.5 | 2.006 | 4.29 | 98 | 67 | 0.68 |
| Example 3 | | | | | | | | |

As described in Table 1, it was found that, in Examples 1 to 3, degradation of the charge and discharge characteristics was small even at the 300^{th} cycle.

On the contrary, it was found that, in Comparative Examples 1 to 3, the charge and discharge characteristics degraded.

As a result of the above-described evaluations, it was found that the present invention is useful.

In this way, due to the present invention, a cathode material having a reduced amount of impurities can be provided. In addition, a method for producing a cathode material capable of easily producing a cathode material having a reduced amount of impurities can be provided. Furthermore, a cathode including the above-described cathode material or a cathode material obtained using the method for producing a cathode material and a lithium ion battery including the cathode can be provided.

### DESCRIPTION OF REFERENCE NUMERALS AND SIGNS

100 LITHIUM ION BATTERY
100 PARTICLE
110 CATHODE
120 ANODE
130 SEPARATOR
140 TERMINAL
150 HOUSING
160 LID

1. A cathode material comprising active material particles formed of a cathode active material,
wherein the cathode active material is LiₓA_{y}D_{z}PO₄, wherein A represents one or more metal elements selected from a group consisting of Fe, Co, Mn, Ni, Cu and Cr, D represents one or more metal elements selected from a group consisting of Mg, Ca, Sr, Ba, Ti, Zn, Ge, Sc, Y and rare earth elements, 0<x≦2, 0<y≦1, and 0≦z<1.5,
an average valence of the metal element represented by A and the metal element represented by D are in a range of 2 to 2.02, and
a particle pH of the active material particles is in a range of 6.5 to 8.5.

2. The cathode material according to claim 1,
wherein the cathode active material is LiMnPO₄.

3. The cathode material according to claim 1,
wherein the active material particles have a carbonaceous material on surfaces thereof and the cathode material includes an aggregate obtained by agglomerating the active material particles as primary particles.

4. A method of producing the cathode material according to claim 1, comprising:
preparing active material particles formed of a cathode active material, wherein
the cathode active material is LiₓA_{y}D_{z}PO₄, wherein A represents one or more metal elements selected from a group consisting of Fe, Co, Mn, Ni, Cu, and Cr, D represents one or more metal elements selected from a group consisting of Mg, Ca, Sr, Ba, Ti, Zn, Ge, Sc, Y and rare earth elements, 0<x≦2, 0<y≦1, and 0≦z<1.5,
exposing the active material particles in an acidic environment having a pH in a range of 4.0 to 6.0, and
obtaining the cathode material from the exposed active material particles.

5. A cathode comprising the cathode material according to claim 1.

6. A lithium ion battery comprising the cathode according to claim 5.
